(19) United States
(12) Patent Application Publication
(10) Pub. No.: US 2002/0123282 A1
(43) Pub. Date: Sep. 5, 2002

(54) Fluoropolymer composites

(76) Inventors: Thomas F. McCarthy, Bennington, VT (US); Richard Foster JR., Buskirk, NY (US)

Correspondence Address: HESLIN ROTHENBERG FARLEY & MESITI PC, 5 COLUMBIA CIRCLE, ALBANY, NY, 12203, US

(21) Appl. No.: 09/753,877

(22) Filed: Jan. 3, 2001

(51) Int. Cl. B32B 5/02; B32B 27/04; B32B 27/12; B32B 1/00; D06N 7/04; B32B 17/04

(52) U.S. Cl. 442/180; 428/143; 442/98; 442/99

(57) ABSTRACT

Food cooking belts and textile belts containing a woven reinforcement, a fluoropolymer, and an interpenetrating network of either a non-fluorinated thermoplastic or a non-fluorinated thermosetting polymer have improved wear resistance, better adhesion to the glass reinforcement, and improved puncture resistance. The non-fluorinated thermoplastic or thermoset is composed of a thermally stable polymer which is stable at temperatures at continuous operating temperatures of 250° C. (500° F.).

### FIELD OF THE INVENTION

The invention relates to fluoropolymer-containing textile composites for use as conveyer belts for food processing and textile manufacturing.

### BACKGROUND OF THE INVENTION

Fluoropolymer coated glass composites are heavily used in the food cooking industries and the textile industries. Fluoropolymers have excellent high temperature stability, low surface energies resulting in non-stick properties, and good flexibility. Belts composed of such composites are used, for example, in bacon cooking manufacturing plants, where the bacon is distributed onto a coated fluoropolymer/fiberglass cloth belt and conveyed through an oven or series of ovens, after which the bacon is removed. The fluoropolymer coated fiberglass woven glass belt is fabricated in such a way that it is a continuous belt operating in a circle. Bacon is placed on the belt and cooked and the belt then returns to the beginning and picks up more bacon. A bacon manufacturing plant may use this food cooking belt for weeks until the belt fails due to grease penetration, bacon adhering to the worn composite, tears or rips in the composite, or actual punctures in the composite.

In another example, square carpet tiles for airports are made in a similar fashion. A 200 yard fluoropolymer coated woven fiberglass belt is conveyed in a loop through process equipment and returns to the beginning. In the case of carpet tiles, a nonwoven substrate may be continuously placed on the belt, coated with a polyurethane glue, followed by another nonwoven substrate, followed by more polyurethane glue, followed by the actual carpet yarn. These components are continuously laminated on top of each other, all on top of the belt. The carpet yarn is spray painted in colorful designs, after which the multilayer carpet is stripped off the fluoropolymer coated fiberglass belt and the belt returns to the beginning. Release properties, tear resistance, puncture resistance, and wear resistance are all important to ensure that the belt lasts months before a new belt must be place on the machines.

Food cooking conveying belts or textile belts are typically manufactured by coating an aqueous fluoropolymer dispersion onto a glass reinforcement. A typical roll of raw fiberglass (industrial application) may have a raw glass weight of 1.2 lb./yd² and coated with a fluoropolymer to a weight of 2.0 lb./yd to generate a 27 mil belt. Generally the fiberglass must be impregnated multiple times with a fluoropolymer dispersion. The raw fiberglass is coated repeatedly with a fluoropolymer dispersion until the desired weight is obtained.

Emulsions containing a fluoropolymer and a non-fluoropolymer component and the polymer composites formed therefrom are known. U.S. Pat. No. 4,546,141 describes a coating composition comprising a fluoropolymer and a polyetherketone (PEK), polyethersulfone (PES), and/or polyarylene sulfide, for use as a primer under a fluoropolymer topcoat. U.S. Pat. Nos. 5,521,230 and 6,040,370, assigned to General Electric, disclose fluoropolymer emulsions containing polycarbonate, acrylonitrile-butadiene-styrene and/or styrene-acrylonitrile resins for formulation as drip retardants. The art does not teach the combination of a textile substrate and a fluoropolymer/non-fluoropolymer composition, or use of such a combination to improve mechanical properties such as abrasion or puncture resistance of belting used under high temperature operating conditions.

### SUMMARY OF THE INVENTION

It has been unexpectedly discovered that incorporation of a thermally stable non-fluoropolymer a separate phase in a fluoropolymer matrix, in at least one layer of a multi-layered coating on a substrate, improves abrasion and puncture resistance and adhesion of the fluoropolymer to the substrate. Accordingly, in one aspect, the invention relates to a conveyer belt comprising a fabric defining a first surface, a second opposing surface and first and second longitudinally-extending edges. The fabric comprises a substrate comprising at least one textile fiber and a polymer composition. The polymer composition comprises 100 parts by weight of a fluoropolymer component comprising at least one fluoropolymer, and 5-150 parts by weight of a non-fluoropolymer component. The non-fluoropolymer comprises at least one non-fluoropolymer having a softening point between 200° C. and 390° C. and a continuous use temperature of at least 200° C.

In particular, the polymer composition may comprise 10-100 parts by weight of the non-fluoropolymer component, and more particularly, 20-80 parts by weight of the non-fluoropolymer component. The fluoropolymer may be derived from the polymerization of one or more monomers selected from the group consisting of tetrafluoroethylene, chlorotrifluoroethylene, vinylidene fluoride, vinyl fluoride, hexafluoropropylene, perfluoroalkylvinylether, ethylene, propylene, alkyvinylethers, and vinyl esters, particularly polytetrafluoroethylene. The fluoropolymer component may also be a fluoroelastomer. The substrate may comprise a textile fiber selected from the group consisting of fiberglass, polytetrafluoroethylene, polybenzoxazoles, polyetheretherketones, carbon, metallics, or a combination thereof, particularly fiberglass. A silicone lubricant precoating may be applied to the substrate.

The non-fluoropolymer may be a thermoplastic polymer, in particular, a polyetheretherketone, polyetherketone, liquid crystal polyester, liquid crystal polyester amide, polyaramide, polyetherimide, polyimide, copolyimide, polyamideimide, polyetherimide, polyethersulfone, polybenzoxazole, polybenzimidazole, polycarbonate, polysulfone, polyketones, polyphenylene sulfide, and/or a combination thereof, and specifically, a polyetheretherketone, a liquid crystal polyester, and/or a liquid crystal polyesteramide. The non-fluoropolymer may also be a thermoset polymer.

The polymer composition may additionally comprise an inorganic filler, particularly aluminum oxide. The substrate may be impregnated with the polymer composition. The polymer composition may form an interpenetrating network of the fluoropolymer component and the non-fluoropolymer component.

In another aspect, the invention relates to method of manufacturing of a conveyer belt. The method comprises applying, to a substrate comprising at least one textile fiber, a polymer composition comprising a fluoropolymer component comprising at least one fluoropolymer and a non-fluoropolymer component comprising at least one non-fluoropolymer having a softening point between 200° C. and 390° C. and a continuous use temperature of at least 200° C. A plurality of layers comprising the polymer composition, and/or at least one layer consisting essentially of a fluoropolymer, and/or a plurality of layers consisting essentially of a fluoropolymer may be applied to the substrate. At least one layer consisting essentially of a fluoropolymer may be applied before and/or after applying the polymer composition.

The substrate and the aqueous dispersion may be additionally heated to at least partly form a film comprising the polymer composition, and/or the film and the substrate may be calendared the film using heat and pressure.

In yet another aspect, the invention relates to a composition comprising a substrate comprising at least one textile fiber; and a polymer composition as described above.

### BRIEF DESCRIPTION OF THE DRAWINGS

FIG. 1 is a scanning electron micrograph (SEM) (500 micron scale) of the polymer composition coating over the fiberglass substrate described in Example 6. The coating comprises polytetrafluoroethylene with 28% Xydar® SRT-900 and 25% aluminum oxide. Xydar® particles are visible at this magnification.

FIG. 2 is a SEM on a 100 micron scale, showing Xydar® particles protruding from the surface of the coating.

FIG. 3 is a SEM on a 5 micron scale, showing aluminum oxide particles embedded in a fibrous network.

### DESCRIPTION OF THE INVENTION

The present invention relates to conveyor belts for use in processing food or manufacturing textile products, and methods for manufacturing the same. A belt according to the present invention comprises a substrate and a polymer composition comprising 100 parts by weight of a fluoropolymer component comprising at least one fluoropolymer; and 5-150 parts by weight of a non-fluoropolymer component comprising at least one non-fluoropolymer having a softening point between 200° C. and 390° C. and a continuous use temperature of at least 200° C. Such a composite material has improved abrasion resistance, improved adhesion of the polymer component to the woven fiberglass, and, in many embodiments, improved puncture resistance. Softening points can be determined by various methods such as thermomechanical analysis, differential scanning calorimetry, and dynamic mechanical methods. Results from these tests will vary. For purpose of this invention, a softening point of 200° C. will imply a continuous operating temperature of 200° C.

A substrate for use in the present invention comprises at least one textile fiber, typically a woven fabric, especially one of a woven fiberglass construction, a woven Kevlar® or Nomex® construction, or a woven textile made from synthetic fibers such as polybenzoxazole (PBO), polyetheretherketones (PEEK), or polytetrafluoroethylene (PTFE), carbon fibers, metallic fibers, or comingled yarns containing any combination of the above. The weave pattern can be any of the following: leno, mock leno, half leno, basketweave, modified basketweave, plain, satin, or twill construction. The yarns may be sized with any number of organic or inorganic sizing or coupling agents including polyvinyl alcohol, starches, oil, polyvinylmethylether, acrylates, polyesters, vinylsilane, aminosilane, titanates, and zirconates. Silicone based lubricants are sometimes employed for greater tear strength. The fibers may be greige goods, partially heat cleaned or fully heat cleaned. Filament size is not critical; 3 microns to 20 microns is appropriate.

The substrate is coated or impregnated with at least one layer of a polymer composition comprising a fluoropolymer and a non-fluoropolymer. The fluoropolymer component of the polymer composition may be a single fluoropolymer or a blend of two or more fluoropolymers. The term “fluoropolymer” is defined herein as a material which is predominantly prepared from fluorinated monomers (greater than 60%); copolymers containing minority components of a non fluorinated monomer are also encompassed by the term. Suitable fluoropolymers include polytetrafluoroethylene, polychlorotrifluoroethylene, copolymers containing vinylidene fluoride and copolymers of polytetrafluoroethylene with small amounts of comonomers such as hexafluoropropylene, chlorotrifluoroethylene, perfluoroalkylvinylethers, or vinylidene fluoride, such as PFA or MFA (copolymers of tetrafluoroethylene and perfluoroalkylvinylethers); FEP (copolymers tetrafluoroethylene and hexafluoropropylene), and ETFE (copolymers of ethylene and tetrafluoroethylene). Any combination of the following monomers may be polymerized to form a suitable fluoropolymer matrix material: tetrafluoroethylene, chlorotrifluoroethylene, vinylidene fluoride, vinyl fluoride, hexafluoropropylene, perfluoroalkylvinylether, ethylene, propylene, non-fluorinated alkyvinylethers, vinyl esters and the like. In addition, fluoroelastomers may also be used as the fluoropolymer, or as a component of a fluoropolymer blend. Fluoroelastomers be prepared from the combinations of the following monomers: vinylidene fluoride, hexafluoropropylene, tetrafluoroethylene, CTFE, ethylene, propylene, perfluoroalkylvinylether, alkylvinylether. Commercially available materials include copolymers of vinylidene fluoride with hexafluoropropylene and copolymers of vinylidene fluoride with hexafluoropropylene and tetrafluoroethylene, and are available as aqueous dispersions.

The fluoropolymer is typically used as an emulsion, latex or aqueous dispersion. Suitable fluoropolymers may be prepared by emulsion polymerization, and are commercially available. Post-emulsification of a fluoropolymer is also readily accomplished, and the resulting emulsions may also be employed. Particle size of the fluoropolymer is not critical. Dispersions having particle size ranging from 0.01 microns to 1.0 microns may be readily employed, with the particle size range between 0.01 and 0.3 microns being preferred. Aqueous dispersions having nanometer-sized particles (10-60 nanometers) are more preferred.

The non-fluoropolymer component of the polymer composition comprises one or more non-fluoropolymers having a softening point between 200° C. and 390° C. and a continuous use temperature of at least 200° C. The non-fluoropolymer should not appreciably degrade at temperatures below about 350° C., and should sufficiently melt or soften at the sintering temperature of the fluoropolymer during manufacturing such that the non-fluoropolymer forms a network within a continuous phase composed of the fluoropolymer. It should also have sufficient release properties such that it is not readily stained or adhered to. The non-fluoropolymer may be a thermoplastic or thermosetting polymer. For the purpose of describing the invention, “thermoplastic” refers to the non-fluorinated component, although it is understood that many of the commercial fluoropolymers can be considered thermoplastics. Possible thermoplastic materials include polyetheretherketones (PEEK™, available from Victrex), PEK (available from the Raychem Corp.), liquid crystalline polyesters and polyester amides (Amoco's Xydar® and Celanese's Vectra), polyaramides (Dupont's Kevlar® and Nomex®, and Akzo's Twaron®), polyetherimides (GE's Ultem®), polyimides, copolyimides, polyamideimides, polyethersulfones having a high enough continuous operating temperature, polybenzoxazole (PBO), polybenzimidazole (Celanese's Celazole®), polycarbonates, polysulfones having a high enough continuous operating temperature, polyetherketones, polyketones, polyphenylenesulfides (PPS), and polyphenylene oxide (PPO) (Noryl®, GE Plastics). Lyotropic or thermotropic liquid crystalline polymers are especially suited for this application. Engineering thermoplastics with high temperature resistance are particularly suitable; PEEK™, and Xydar® are preferred. The non-fluoropolymer component is added for improved wear resistance, puncture resistance, and adhesion to the glass matrix.

Non-fluorinated temperature-resistant thermosetting polymers may also be used as the non-fluoropolymer component. A single thermoset material may be used, or a blend of thermosetting polymers or of thermosetting polymer(s) and thermoplastic polymer(s). Typical examples include: amine cured epoxy novolacs; epoxies cured with diamines (1,4-paraphenylenediamine, 4,4′-diaminodiphenyl sulfone etc.) bismaleimides which may include diallylbisphenol A and 4,4′-bis-(maleimidodiphenyl) propane (BMI), styrene-maleic anhydride copolymers cured with epoxies; thermosetting polyimides; bismaleimide triazine resins, triazine resins, phenolic triazine resins, thermosetting polyphenylene oxide based oligomers, and the like. An advantage of using thermosetting resins is that the individual components can be readily ground down to very fine particle sizes and emulsified in a ball mill or the like.

Minority components of a non-fluorinated polymer that do not meet the temperature requirements stated above may be added to the fluoropolymer dispersion. Such materials may be used at any time in a multiple pass coating construction. These include polyalkylvinylethers, polystyrene; acrylics, polyvinyl esters, polyvinyl chloride or polyvinylidene chloride, elastomers such as polybutadiene, polyisoprene, and neoprene which are available as aqueous dispersions. Water soluble polymers such as polymethylvinylether, polyvinyl alcohol, polyethylene oxide, and polyvinylpyrrolidone. These polymers typically soften at the continuous operating temperatures usually associated with industrial textile applications and commercial food cooking. However, there may be room temperature applications where polymers having low glass transition temperatures or low melting points may be employed.

The non-fluoropolymer component is typically ground to small particles starting from coarse powder, fine powder, or fibers, since a fine particle size that lies flat is desirable for coating of the dispersion on a woven glass reinforcement. The particle size of the non-fluoropolymer component is typically less than 200 microns, preferably from 0.1 to 75 microns, and more preferably from 0.1 to 10 microns. The non-fluoropolymer can be milled to this size using, for example, a hammer mill, a ball mill, or an air jet mill, with or without cryogenic grinding. The milled non-fluoropolymer may be added as a powder to an aqueous fluoropolymer dispersion. Alternatively, the non-fluoropolymer may be milled in the presence of water and an emulsifier to yield an aqueous dispersion of the material. The dispersion may then be combined with an aqueous dispersion of the fluoropolymer. The addition of non-fluoropolymer particles may increase the viscosity of the fluoropolymer dispersion, depending on the size of the particles. In some cases, thickening of the non-fluoropolymer/fluoropolymer dispersion with a commercial thickener, such as one of the Acrysol® series from the Rohm and Haas Co., may be desirable to ensure that the components do not settle out.

The amount of non-fluoropolymer used ranges from 5-150 parts by weight (pbw), based on 100 parts by weight fluoropolymer. Preferably 10-100 pbw non-fluoropolymer to 100 pbw fluoropolymer is used, and more preferably 25-70 pbw non-fluoropolymer to 100 pbw fluoropolymer. This may be expressed as a ratio of fluoropolymer to non-fluoropolymer. The ratio of fluoropolymer to non-fluoropolymer used ranges from 20:1 to 1:1.5, preferably from 10:1 to 1:1, and most preferably, from 4:1 to 3:2, based on dried solids. It should be understood that the non-fluoropolymer is typically present as a component of one or more layers of a plurality of layers coating or impregnating the substrate, and is not present in all of the layers. It is preferred that the non-fluoropolymer not be added to the fluoropolymer dispersion when base coating the fiberglass (the first 2-3 passes), although there may be some cases where it is desirable to use a thermoplastic additive to each pass of fluoropolymer dispersion. It is most preferred that the thermoplastic additive be added to the middle passes of a multipass construction. For example, 10 coating passes or layers may be required to coat a woven fiberglass substrate for use as a food cooking or textile belt. In this case, a typical construction is 1-4 initial non-filled coating passes to impregnate the glass bundles. The third through seventh passes may include a non-fluoropolymer or the combination of a non-fluoropolymer with an additional filler. In some applications it may be necessary to topcoat the composite 1-4 times with an aqueous dispersion which is unfilled to achieve a smooth surface. In the finished textile composite, total polymer weight typically comprises approximately one third of the weight of the total textile composite; layers containing a non-fluoropolymer may comprise about one third of the total polymer weight. Therefore, based on the total weight of the composite, the weight of non-fluoropolymer will be from 3 wt % to 50 wt %. The thermoplastic will be more preferred to be 7 wt % to 45 wt % based on the total weight of the composite. In the most preferred embodiment, the thermoplastic will be from 8 wt % to 40 wt % based on the total weight of the construction.

A belt according to the present invention may additionally comprise an organic or inorganic filler. For example, antistatic textile belts generally contain graphite in many passes to conduct static electricity. The filler may be included in one or more layers. The filler(s) may be added to dispersions containing a fluoropolymer only, or containing the polymer composition described above. The belt is topcoated with a fluoropolymer containing graphite, and it is not necessary that the topcoat contain a non-fluoropolymer component. The filler may be a pigment, an inorganic solid, a metal, or an organic. Typical pigments include: titanium dioxide, carbon black, graphite, or various burnt umber iron oxides. Other inorganic fillers include talc, calcium carbonate, silica, al oxide, glass spheres (hollow or solid) of various particle sizes, nanometer-sized particles of silica or alumina, mica, corundum, wollastonite, silicon nitride, boron nitride, al nitride, silicon carbide, beryllia, and clays. Metallic fillers include copper, al, stainless steel and iron. Organic fillers include wax and crosslinked rubber particles. Alumina is a preferred filler. Fillers are chosen based on cost, thermal properties, and mechanical properties desired. Particle size of the filler ranges from 0.01 to 100 microns. For each coating pass, or layer, the filler may be present in an amount ranging from 100:1 to 3:2 based on a ratio of polymer solids to filler. Fillers may be used in the form of a powder or as an aqueous dispersion. Incorporation of the filler in a layer containing a non-fluoropolymer typically has a synergistic effect with the non-fluoropolymer, because non-fluoropolymers are frequently more efficient binders for the filler than fluoropolymers.

A method of manufacturing a conveyer belt according to the present invention comprises applying, to a substrate comprising at least one textile fiber, at least one layer of a polymer composition comprising a fluoropolymer component comprising at least one fluoropolymer and a non-fluoropolymer component comprising at least one non-fluoropolymer having a softening point between 200° C. and 390° C. and a continuous use temperature of at least 200° C. A plurality of layers comprising the polymer composition may be applied. Typically, multiple layers of the same or varying composition, each containing a fluoropolymer, are applied 10 sequentially to the substrate. At least one layer consisting essentially of a fluoropolymer, that is, not containing a non-fluoropolymer, is preferably used, and more preferably, a plurality of layers consisting essentially of a fluoropolymer is applied. These layers may be applied either before or after applying the polymer composition, or both before and after.

Conveyer belts for use in processing textile or food are thus typically manufactured according to the present invention in the following manner. A substrate as described above, for example, woven fiberglass, is immersed in a bath containing a fluoropolymer dispersion or latex. The amount of latex picked up by the substrate is controlled by wrapped wire-wound bars, smooth bars, reverse rolls, and the like. The coating may also be applied by known methods such as dip coating, knife coating, knife over roll coating, or spray coating. Typically the substrate is coated repeatedly with a fluoropolymer dispersion to completely cover the knuckles in a plain weave fiberglass construction. Generally it is preferred but not required that the first few passes contain only fluoropolymer, and that 2-3 base layers of a fluoropolymer are coated onto the substrate before any layers containing a non-fluoropolymer component in addition to the fluoropolymer component be used. In addition, specific gravity of the latex should not be too high (less than 1.5 g/cm²), and the latex should have a viscosity less than 100 centipoise. Incorporating a high modulus thermoplastic or a filler into the base pass on a woven fiberglass reinforcement may lead to a brittle product. The woven fiberglass may be pretreated with a lubricant, such as polyphenylmethylsiloxane or polydimethylsiloxane, before coating with the fluoropolymer.

After impregnation of the woven fiberglass bundles by immersion into a dip pan and metering of the aqueous dispersion by a metering rod, the coated substrate travels under tension on rollers through a drying oven, where the water is removed. The oven may operate on radiant heat, or forced air or infrared heating. Typically, the temperature of the drying oven ranges from 200-400° F. (93-204° C.). The drying oven(s) may contain one or more sequential zones. In a five-zone setup, the first zone may be forced air with no heat. Generally, the temperature of the zones is set such that the coated substrate travels through increasingly higher temperatures. For example, a three-zone oven may have the first zone set at 400° F. (204° C.), the second zone at 550° F. (288° C.) and a third sintering zone at 765° F. (407° C.).

For a typical textile or food belt, the first 2-3 layers contain no non-fluoropolymer, the intermediate layers (fourth through sixth or seventh) contain a non-fluoropolymer component in the amounts specified above, and the top layer(s) may or may not contain any non-fluoropolymer. Non-fluoropolymers may be incorporated into the top layer of coating, if desired, depending on the particle size of the additives, and the desired smoothness of the belt. When a very smooth product is desired, additional unfilled layers of fluoropolymer may be applied to obtain a smooth surface if the intermediate layers contain a non-fluoropolymer having large and irregular particle sizes. If surface smoothness is not critical, non-fluoropolymer may be incorporated all the way to the surface of the belt. Lack of surface smoothness can also be remedied by passing the coated fabric through a calendar. It has been found that calendering a thermoplastic non-fluoropolymer-filled textile belt at about 425° F. (218° C.) under pressure of 600 pounds per linear inch (pli) results in a product which remains smooth even after later exposures to neat PTFE processing temperatures.

As stated previously, the non-fluoropolymer has excellent thermal stability at use temperatures, which typically range from about 70-550° F., and does not appreciably degrade below about 350° C. In addition, for ease in manufacturing, it is preferred that the non-fluoropolymer be thermally stable at the fusion temperatures of PTFE (765° F.) (407° C.). However, it may not be necessary that the non-fluoropolymer have stability at such a high temperature because the material may be exposed to this temperature for no more than a few minutes. During manufacture, the belts typically travel at speeds ranging from 1-20 feet/minute through the ovens, depending on the number of ovens and the design of the ovens, and thus the time during which the non-fluoropolymer is exposed to high temperatures is limited.

A textile belt made according to this invention has an effective operating life that is two to four times the life of a comparative belt made according to prior art methods. An additional benefit of the invention is that textile belts can be manufactured with fewer coating passes. By adding a thermoplastic solid filler to a fluoropolymer dispersion, the total solids level in the fluoropolymer dispersion is raised, such that a greater amount of polymer solids is applied per pass, and excellent pickup is be obtained without coating defects. The combination of high loading of a solid non-fluoropolymer and an inorganic filler such as alumina with a fluoropolymer dispersion leads to even higher solid content dispersions. This enables very high coating pickup weights. Textile belts have been prepared by the method of the present invention using half the number of coating passes typically used in the prior art.

In another embodiment of the invention, the polymer composition may be applied to the substrate in the form of a cast film. The film may be prepared by blending the non-fluoropolymer with an aqueous dispersion of a fluoropolymer in the previously described ratios, including the additives previously described, if desired. Instead of coating a woven carrier such as woven fiberglass, a film is formed by coating a carrier such as polyimide film, a stainless steel roll, an aluminum roll, a copper roll, or any plastic or metal continuous rolled good which is dimensionally stable at 765° F. (407° C.). By successively coating a continuous sheet of polyimide film, for example, a 0.25-10 mil film can be obtained. The carrier may be coated using flow coating, metering rods, knife over roll, reverse roll, pad coating, spray coating and the like. The polymer composition is then stripped from the carrier as a film. The cast film may be hot roll calendared to a reinforcement such as a fabric composed of glass, Kevlar, or Nomex fibers. It is preferred that the glass fabric be preimpregnated with a fluoropolymer to ensure good bonding of the film to the reinforcement. Alternately, the reinforcement may be precoated with a fused or semifused fluoropolymer before the polymer composition is laminated or pressed onto the reinforcement. If the temperature of the pressing is lower than the melting temperature of the fluoropolymer in the polymer composition, one or more dipcoating passes over the polymer composition film may be needed to ensure good bonding between the layers. Cast film may be laminated on one or both sides of the reinforcement. This construction has the advantage that the knuckles of the fabric are more readily covered by a uniform thickness of the polymer composition.

To further illustrate the scope of the invention the following examples are provided:

### EXAMPLES

### Example 1

### Fiberglass/Fluoropolymer Composite (Comparative Example C1)

A fiberglass fabric substrate was coated with multiple layers of PTFE to produce a material suitable for use as a conveyor belt for food and textile operations. A food grade 7628 style woven fiberglass with a 508 partially heat cleaned finish, and having a bare weight of 6 ounces/yd² was used as the substrate. The fiberglass fabric was pulled under tension through a dip pan containing an aqueous dispersion of polytetrafluoroethylene. For the initial coating pass, the dispersion was metered on by a set of smooth bars and the specific gravity of the PTFE dispersion was 1.35. The fiberglass then traveled through a single zone oven at a speed of 5 ft per/min with an upper temperature of 570° F. (299° C.). The single zone oven is designed with a radiant tube which starts at the top of the oven and is horizontal across the top, and then is directed gradually from the top to the bottom in a series of horizontal sections connected by short vertical sections. Propane gas is ignited at the top of the oven and is passed through the radiant tube. In such a construction, the top of the oven is the hottest, and it becomes progressively cooler as the substrate moves from top to bottom of the oven. Heat in the oven is controlled by adjusting a setpoint corresponding to the hottest point of the oven located at the top. For subsequent coating passes, the specific gravity of the aqueous dispersion used, the speed, the temperature, and the width of the wrapped wire bars used to meter the dispersion were adjusted. These details are set forth in Table 1.

TABLE 1
Process Parameters - Comparative Example

| Coating | Dispersion specific | Speed | Temp | Metering |
|---|---|---|---|---|
| Pass | Gravity (g/cm2) | (ft/min) | ° F. (° C.) | bars |
| 1 | 1.35 | 5 | 570 (299) | smooth |
| 2 | 1.45 | 5 | 627 (331) | smooth |
| 3 | 1.45 | 5 | 638 (337) | smooth |
| 4 | 1.45 | 2.7 | 735 (391) | smooth |
| 5 | 1.45 | 3.5 | 725 (385) | smooth |
| 6 | 1.45 | 3.5 | 725 | smooth |
| 7 | 1.45 | 3 | 725 | 0.032″ |
| | | | | wire |
| 8 | 1.45 | 3.5 | 725 | 0.032″ |
| | | | | wire |
| 9 | 1.45 | 3.5 | 725 | 0.032″ |
| | | | | wire |
| 10 | 1.2 (PFA) | 6 | 725 | smooth |

The fabric was coated to a final weight of 0.90 lb./yd². Mechanical properties of the belt are summarized in Table 2.

### Example 2

### Composite Containing Polyetheretherketone (PEEK™) (E1)

A woven 7628 style fiberglass was coated as in Example 1 for passes 1 through 3 and 8 through 10. A fluoropolymer dispersion containing 19.4% (solid/solids) PEEK™ was used for coating passes 4-7. All coating passes containing PEEK™ were applied with a smooth metering bar. The dispersion was prepared by adding 12 pounds of polyetheretherketone (Victrex, USA) having a mean particle size of 30 microns and a range of 20-100 microns to an aqueous dispersion of polytetrafluoroethylene (specific gravity of 1.45, 55% solids in water), to yield a blend containing 19.4% PEEK™ based on total dry solids. Viscosity of the dispersion was adjusted to 100 cp with Acrysol ASE-60 (Rohm and Haas Company).

Mechanical properties of the composite are summarized in Table 2. The fabric showed modest improvements in tear strength and adhesive strength to the glass relative to the comparative example, and but showed a significantly higher total energy to puncture, and much lower Taber abrasion loss.

### Example 3

### Textile Belting Composite Containing 10% Polyetheretherketone (PEEK™) (E2)

Example 2 was repeated with the exception that a 10 wt % concentration of PEEK™ based on total dried polymer solids was used in coating passes 5-8. Passes 7-10 used a smooth bar to apply the dispersion. Mechanical properties of the composite appear in Table 2. The composite showed a modest improvement in adhesive strength to the glass, a significantly higher energy to puncture, and no improvement in Taber abrasion loss. This example demonstrates that at the 10% loading in passes 5-8, only an increase in puncture resistance can be expected.

### Example 4

### Belting Composite Containing Polyetheretherketone (PEEK™) and a Silicon Glass Lubricant (E3)

The procedure of Example 1 was used with the following modifications. Before the raw fiberglass was coated with the fluoropolymer dispersion, it was passed through an aqueous dispersion of a polyphenylmethylsiloxane(available from Dow Corning as ET-4327) to lubricate the yarn bundles (1.5% solution of siloxane in water). The siloxane/fluoropolymer dispersion was fused using an upper oven temperature of 570° F. (229° C.) and was applied using no metering bars (5 ft/min.). Passes 4 and 5 contained a 20% concentration of PEEK™ based on solids of PEEK™ to total dried solids. Example 4 was prepared to see the effect of the lubricant on the textile belt's tear properties and adhesion properties. As seen in Table 1, there is a significant improvement in tear strength and a modest drop in adhesive strength. However, the energy required to puncture is a significant improvement over all constructions. A similar experiment was conducted using a 0.5% concentration of siloxane in water to coat the raw glass. This textile belt showed as good puncture properties and a reduced drop in coating adhesive strength to the glass.

### Example 5

### Belting Composite Containing a Liquid Crystalline Polymer (E4)

A fluoropolymer dispersion was formulated containing 28 wt % of Xydar® SRT-900 (concentration of Xydar® based on total dried solids), a liquid crystalline polyester having a particle size with less an 1% retention on a 200 mesh screen (available from Amoco Performance Polymers). The polytetrafluoroethylene dispersion containing Xydar® was used on passes 4-7 and applied using a smooth metering rod. There were only two additional passes of a modified polytetrafluoroethylene dispersion (specific gravity equal to 1.45, Algoflon 3312X available from Ausimont S.PA., Italy) which were also applied using smooth metering rods. Total composite weight was 1.05 lb./yd². Resulting mechanical properties are summarized in Table 2. This construction eliminated one coating pass and still achieved the same coating weight. This example demonstrates an improved coating adhesion to glass and improved tear strength.

### Example 6

### Belting Composite Containing an Inorganic Filler, Aluminum Oxide (E5)

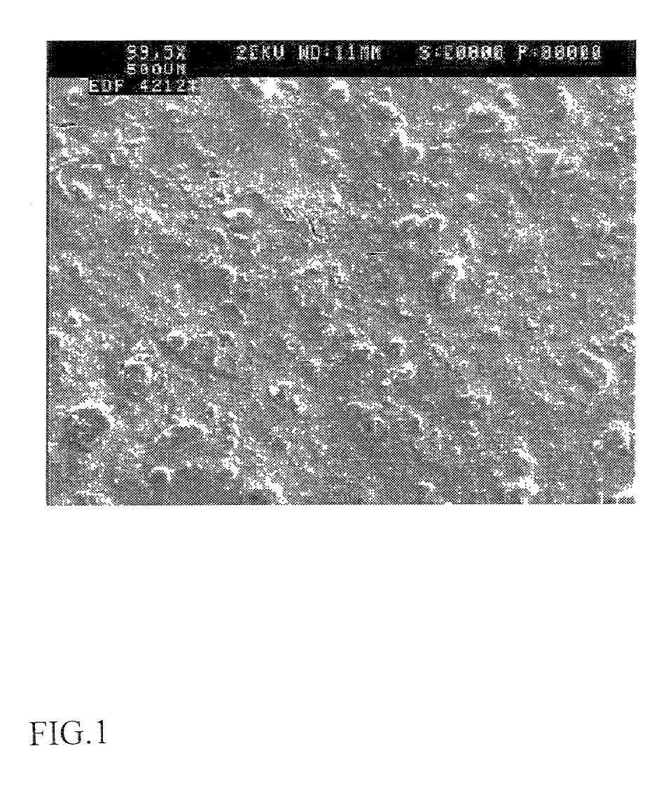

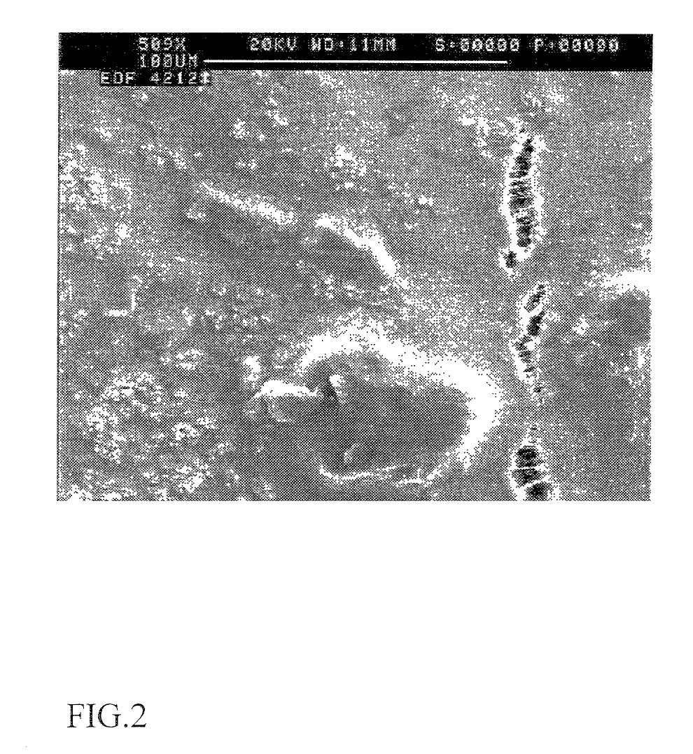

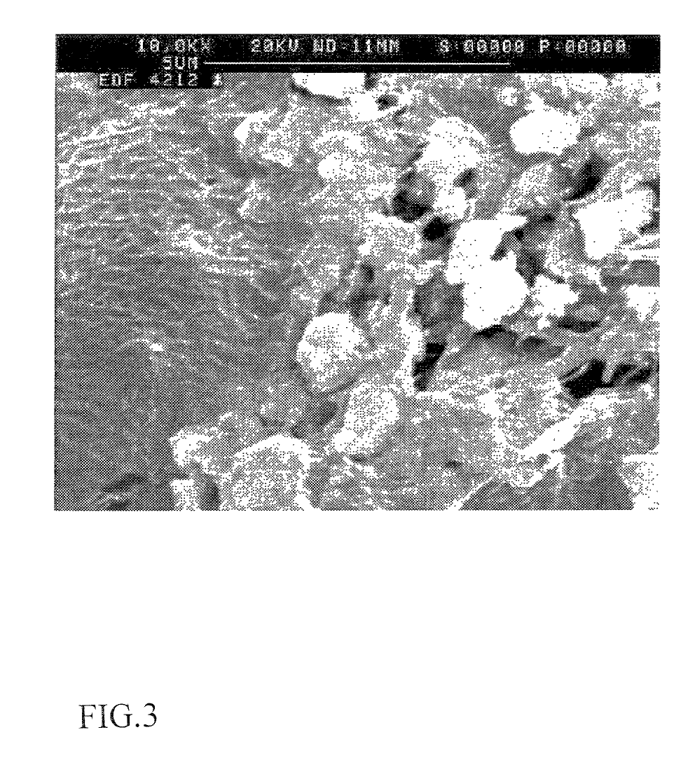

7628 glass having a 718 finish was used (completely heat cleaned with a silane binder). This glass style is an electronics grade glass and is expected to have lower tensile and tear values due to the weakening caused by a full heat cleaning. A polytetrafluoroethylene aqueous dispersion was formulated having 28% Xydar® SRT-900 and 25% aluminum oxide (Baikowski International Corporation, Duralox® OR) based on total dried solids. The filled passes were passes 4-6. Pass 10 was omitted. Results are shown in Table 2. This composite showed a very low Taber abrasion loss, but the measurement is misleading because in most measurements of weight loss after 500 cycles of abrasion some degree of exposed glass is present. In this particular case, no exposed glass could be observed, suggesting that there is sufficient coating over the glass knuckles to give a uniform coating over the glass surface which follows the contours of the fabric, rather than just filling in between the valleys, between the knuckles. An improvement in adhesion to glass is also evident. Tensile and tear values are not representative because a totally heat cleaned fabric was used. Puncture performance is noticeably worse suggesting that this composite is too stiff or brittle for applications where puncture is a problem. Again, at the higher filler loading levels, composites can be prepared with reduced coating passes. FIG. 1 shows a scanning electron microscope picture of the composite after pass 6. The scale is 500 microns. The Xydar® particles can be readily observed in the matrix. FIG. 2 shows a scanning electron microscope micrograph at higher resolution, having a 100 micron scale. The Xydar® particle can be readily seen protruding from the surface. FIG. 3 shows a micrograph at the highest resolution, having a 5 micron scale. The aluminum oxide particles can be readily seen and look to be embedded in a fibrous network.

### Example 7

### Belting Composite Containing a Polyetherimide (E6)

A fluoropolymer dispersion was formulated containing 20 wt % Ultem® 1000 (GE Plastics, Pittsfield, Mass.) which was ground to a fine particle having less than 1% retention on a 125 mesh screen. Passes 4-5 were conducted using the Ultem® filled dispersion. Passes 6-8 were a polytetrafluoroethylene dispersion applied using a 12 wire bar, while the 9^{th} pass used smooth metering rods to apply the same dispersion. The product was top coated with a 1.2 specific gravity aqueous dispersion of PFA using smooth metering rods. The mechanical properties are summarize in Table 1. A noticeable improvement in tensile properties and the adhesion to glass were observed. The abrasion loss was less than 1%.

### Example 8

### Textile Belt containing a Thermosetting Resin (E7)

A fluoropolymer dispersion was formulated containing 28 wt % (based on total dried solids) of a thermosetting formulation. A 1:1 molar ratio of 4,4′bis-(maleimidodiphenyl) methane (BMI) and 2,2′-bis(3-allyl-4-hydroxyphenyl)propane (diallylbisphenol A) was used to form an aqueous dispersion by grinding the powders in a ball mill in the presence of a nonionic surfactant, Triton® X-100 available from Union Carbide, and 0.5% of a xanthum gum thickener. Coating was conducted according to comparative example 1. The aqueous dispersion of the thermosetting resin was added to the aqueous fluoropolymer dispersion and was used in coating passes 4-7. This example demonstrates that a thermosetting resin can be used to prepare an interpenetrating network of a non fluorinated thermosetting polymer within a fluoropolymer matrix.

### Example 9

### Textile Belt containing a Thermosetting Resin (E8)

A fluoropolymer dispersion was formulated containing 28 wt % (based on total dried solids) of a thermosetting formulation. A 1:1 molar ratio of 4,4′-diaminodiphenylsulfone and Tactix® 556 available from Ciba Specialty Chemicals (a phenol based polymer with 3a, 4, 7, 7a-tetrahydro-4,7-methano-1H-indene, glycidyl ether) was used to form an aqueous dispersion by grinding the powders in a ball mill in the presence of a nonionic surfactant, Triton® X-100 available from Union Carbide, and 0.5% of a thickener, xanthum gum. Coating was conducted according to comparative example 1. The aqueous dispersion of the thermosetting resin was added to the aqueous fluoropolymer dispersion and was used in coating passes 4-7. This example demonstrates that a thermosetting resin can be used to prepare an interpenetrating network of a non fluorinated thermosetting polymer within a fluoropolymer matrix.

In Table 2 the relative properties of the various textile belts manufactured are compared. Mechanical properties were measured in the warp (w, machine coating direction) and fill (f, transverse) directions. Puncture properties were measured according to ASTM D-3763-98. Tear strength was measured according to ASTM D-1117-80. Tensile strength was measured according to ASTM D-902-89. Adhesion of the composite to the glass was measured according to ASTM D-751-95. Weight loss from abrasion was measured according to ASTM D3884.

TABLE 2
Comparative Adhesion, Puncture, Abrasion,
and Tensile Properties of Coated Fiberglass Composites.

| | | | | | | Abra- |
|---|---|---|---|---|---|---|
| | | | | Punc- | Puncture: | sion |
| | Tensile | | | ture: | (total | weight |
| | Strength | Tear | Adhesion | (time to | energy | loss (%) |
| | (w/f; | (w/f; | (w/f: | break; | to break; | 500 |
| Sample | lb./in) | lb./in) | lb./in) | msec) | joules) | cycles |
| C1 | 352/255 | 12.3/6.9 | 5/5.5 | 2.4 | 1.98 | 1.95 |
| E1 | 348/281 | 14.3/8.6 | 5.7/6.25 | 4.0 | 2.84 | 0.31 |
| E2 | 355/337 | 13.6/6.3 | 7.4/7.2 | 3.2-4.7 | 2.85 | 2.0 |
| E3 | 336/211 | 17.2/15.6 | 4.9/4.1 | 2.8-4.0 | 3.54 | — |
| E4 | 326/278 | 13.2/9.7 | 7.0/6.5 | — | — | 0.7 |
| E5 | 193/149 | 3.5/2.57 | 6.5/6.8 | 1.3-2.5 | 1.27 | 0.3 |
| E6 | 401/324 | 12.8/8.5 | 8.35/7.62 | — | — | 0.9 |

### Example 10

### Textile Belt Prepared from a Thermoplastic Filled Cast Film and a Woven Glass Reinforcement

An aqueous dispersion of a modified PTFE having a specific gravity of 1.35 is combined with PEEK™ powder generating an aqueous dispersion having 28% PEEK™ based on total dry polymer solids. The dispersion is dipcoated onto a 5 mil Kapton polyimide carrier. The dispersion is dipcoated on the carrier at 2 feet/minute using no metering rods (flow coating). The film is dried by passing through a three-zone oven set at 400° F., 550° F., and 720° F. The carrier is recoated two additional times to yield a coated thickness of 1 mil on each side of the Kapton. The cast film is removed from the carrier by mechanical stripping. In a separate step, 7628 greige glass is impregnated and coated three times with a 1.40 specific gravity modified PTFE dispersion. A smooth metering bar is used on the first pass, followed by a 0.12 inch wire bar on the succeeding two passes. The first and third passes are semifused. The following temperatures are used for the first and third passes: 400° F., 550° F., and 620° F. The second pass used 400° F., 550° F., and 725° F. The 1 mil cast film is then laminated onto both sides of the coated fiberglass using a double steel roll calendar operated at 450° F. and 750 pli. After applying the cast film, the resulting composite is topcoated with a 1.45 specific gravity modified PTFE dispersion at 5 feet/minute, 0.12 inch wire bars and the following temperatures: 400° F., 550° F., and 750° F. This example demonstrates that the non-fluoropolymer component can be incorporated into a fluoropolymer matrix as a blend in the absence of a reinforcement, in the form of a film, and then can be laminated or calendared onto a reinforcement in a separate step.

What is claimed is:

1. A conveyer belt comprising a fabric defining a first surface, a second opposing surface and first and second longitudinally-extending edges, the fabric comprising:
a substrate comprising at least one textile fiber; and
a polymer composition comprising:
100 parts by weight of a fluoropolymer component comprising at least one fluoropolymer; and
5-150 parts by weight of a non-fluoropolymer component comprising at least one non-fluoropolymer having a softening point between 200° C. and 390° C. and a continuous use temperature of at least 200° C.

2. A conveyer belt according to claim 1 wherein the polymer composition comprises 10-100 parts by weight of the non-fluoropolymer component.

3. A conveyer belt according to claim 1 wherein the polymer composition comprises 20-80 parts by weight of the non-fluoropolymer component.

4. A conveyer belt according to claim 1 wherein the at least one fluoropolymer is at least one fluoropolymer derived from the polymerization of one or more monomers selected from the group consisting of tetrafluoroethylene, chlorotrifluoroethylene, vinylidene fluoride, vinyl fluoride, hexafluoropropylene, perfluoroalkylvinylether, ethylene, propylene, alkyvinylethers, and vinyl esters.

5. A conveyer belt according to claim 4 wherein the at least one fluoropolymer is polytetrafluoroethylene.

6. A conveyer belt according to claim 1 wherein the fluoropolymer component comprises a fluoroelastomer.

7. A conveyer belt according to claim I wherein said at least one textile fiber is selected from the group consisting of fiberglass, polytetrafluoroethylene, polybenzoxazoles, polyetheretherketones, carbon, metallics, or a combination thereof.

8. A conveyer belt according to claim 7 wherein said at least one textile fiber is fiberglass.

9. A composition according to claim 8 wherein the substrate comprises a silicone lubricant precoating.

10. A conveyer belt according to claim 1 wherein said at least one non-fluoropolymer is a thermoplastic polymer.

11. A conveyer belt according to claim 10 wherein said at least one non-fluoropolymer is selected from the group consisting of polyetheretherketones, polyetherketones, liquid crystal polyesters, liquid crystal polyester amides, polyaramides, polyimides, copolyimides, polyetherimides, polyamideimides, polyethersulfones, polybenzoxazoles, polybenzimidazoles, polycarbonates, polysulfones, polyketones, polyphenylene sulfides, and combinations thereof.

12. A conveyer belt according to claim 11 wherein said at least one non-fluoropolymer is a polyetheretherketone.

13. A conveyer belt according to claim 11 wherein said at least one non-fluoropolymer is a liquid crystal polyester or a liquid crystal polyesteramide.

14. A conveyer belt according to claim 11 wherein said at least one non-fluoropolymer is a polyimide.

15. A conveyer belt according to claim 11 wherein said at least one non-fluoropolymer is a polyetherimide.

16. A conveyer belt according to claim 1 wherein said at least one non-fluoropolymer is a thermoset polymer.

17. A conveyer belt according to claim 1 wherein the polymer composition additionally comprises an inorganic filler.

18. A conveyer belt according to claim 17 wherein the inorganic filler is aluminum oxide.

19. A conveyer belt according to claim 1 wherein the substrate is impregnated with the polymer composition.

20. A conveyer belt according to claim 1 wherein the polymer composition forms an interpenetrating network of the fluoropolymer component and the non-fluoropolymer component.

21. A method of manufacturing of a conveyer belt comprising applying, to a substrate comprising at least one textile fiber, a polymer composition comprising a fluoropolymer component comprising at least one fluoropolymer and a non-fluoropolymer component comprising at least one non-fluoropolymer having a softening point between 200° C. and 390° C. and a continuous use temperature of at least 200° C.

22. A method according to claim 21 wherein a plurality of layers comprising the polymer composition are applied to the substrate.

23. A method according to claim 21, additionally comprising applying to the substrate at least one layer consisting essentially of a fluoropolymer.

24. A method according to claim 23, wherein a plurality of layers consisting essentially of a fluoropolymer are applied to the substrate.

25. A method according to claim 23, wherein said at least one layer consisting essentially of a fluoropolymer is applied before applying the polymer composition.

26. A method according to claim 23, wherein said at least one layer consisting essentially of a fluoropolymer is applied after applying the polymer composition.

27. A method according to claim 23, wherein said at least one layer consisting essentially of a fluoropolymer is applied before and after applying the polymer composition.

28. A method according to claim 21, wherein applying the polymer composition comprises:
applying, to the substrate, an aqueous dispersion comprising the polymer composition; and
heating the substrate and the aqueous dispersion to at least partly form a film comprising the polymer composition.

29. A method according to claim 28 wherein particle size of the at least one non-fluoropolymer ranges from 0.01-200 microns.

30. A method according to claim 28, wherein the substrate additionally comprises at least one layer consisting essentially of a fluoropolymer.

31. A method according to claim 28, wherein the substrate additionally comprises the polymer composition.

32. A method according to claim 21, wherein applying the polymer composition comprises:
applying, to the substrate, a film comprising the polymer composition; and
calendaring the film and the substrate using heat and pressure.

33. A method according to claim 32, wherein the substrate additionally comprises at least one layer consisting essentially of a fluoropolymer.

34. A method according to claim 33, wherein the substrate additionally comprises the polymer composition.

35. A method according to claim 21 wherein the polymer composition comprises:
100 parts by weight fluoropolymer component; and
5-150 parts by weight non-fluoropolymer component.

36. A method according to claim 35 wherein the polymer composition comprises 10-100 parts by weight of the non-fluoropolymer component.

37. A method according to claim 35 wherein the polymer composition comprises 20-80 parts by weight of the non-fluoropolymer component.

38. A method according to claim 35 wherein the at least one fluoropolymer is at least one fluoropolymer derived from the polymerization of one or more monomers selected from the group consisting of tetrafluoroethylene, chlorotrifluoroethylene, vinylidene fluoride, vinyl fluoride, hexafluoropropylene, perfluoroalkylvinylether, ethylene, propylene, alkyvinylethers, and vinyl esters.

39. A method according to claim 38 wherein said at least one fluoropolymer is polytetrafluoroethylene.

40. A method according to claim 35 wherein the fluoropolymer component comprises a fluoroelastomer.

41. A method according to claim 35 wherein said at least one textile fiber is selected from the group consisting of fiberglass, polytetrafluoroethylene, polybenzoxazoles, polyetheretherketones, carbon, metallics, or a combination thereof.

42. A method according to claim 41 wherein said at least one textile fiber is fiberglass.

43. A method according to claim 42 wherein the substrate comprises a silicone lubricant precoating.

44. A method according to claim 35 wherein said at least one non-fluoropolymer is a thermoplastic polymer.

45. A method according to claim 43 wherein said at least one non-fluoropolymer is selected from the group consisting of polyetheretherketones, polyetherketones, liquid crystal polyesters, liquid crystal polyester amides, polyaramides, polyimides, copolyimides, polyetherimides, polyamideimides, polyethersulfones, polybenzoxazoles, polybenzimidazoles, polycarbonates, polysulfones, polyketones, polyphenylene sulfides, and combinations thereof.

46. A method according to claim 45 wherein said at least one non-fluoropolymer is a polyetheretherketone.

47. A method according to claim 45 wherein said at least one non-fluoropolymer is a liquid crystal polyester or a liquid crystal polyesteramide.

48. A method according to claim 45 wherein said at least one non-fluoropolymer is a polyimide.

49. A method according to claim 45 wherein said at least one non-fluoropolymer is a polyetherimide.

50. A method according to claim 35 wherein said at least one non-fluoropolymer is a thermoset polymer.

51. A method according to claim 35 wherein the polymer composition additionally comprises an inorganic filler.

52. A method according to claim 51 wherein the inorganic filler is aluminum oxide.

53. A method according to claim 28 wherein the substrate is impregnated with the polymer composition.

54. A method according to claim 35 wherein the polymer composition forms an interpenetrating network of the fluoropolymer component and the non-fluoropolymer component.

55. A composition comprising:
a substrate comprising at least one textile fiber; and
a polymer composition comprising:
100 parts by weight of a fluoropolymer component comprising at least one fluoropolymer; and
5-150 parts by weight of a non-fluoropolymer component comprising at least one non-fluoropolymer having a softening point between 200° C. and 390° C. and a continuous use temperature of at least 200° C.

56. A composition according to claim 55 wherein the polymer composition comprises 10-100 parts by weight of the non-fluoropolymer component.

57. A composition according to claim 55 wherein the polymer composition comprises 20-80 parts by weight of the non-fluoropolymer component.

58. A composition according to claim 55 wherein the at least one fluoropolymer is at least one fluoropolymer derived from the polymerization of one or more monomers selected from the group consisting of tetrafluoroethylene, chlorotrifluoroethylene, vinylidene fluoride, vinyl fluoride, hexafluoropropylene, perfluoroalkylvinylether, ethylene, propylene, alkyvinylethers, and vinyl esters.

59. A composition according to claim 58 wherein said at least one fluoropolymer is polytetrafluoroethylene.

60. A composition according to claim 55 wherein the fluoropolymer component comprises a fluoroelastomer.

61. A composition according to claim 55 wherein said at least one textile fiber is selected from the group consisting of fiberglass, polytetrafluoroethylene, polybenzoxazoles, polyetheretherketones, carbon, metallics, or a combination thereof.

62. A composition according to claim 61 wherein said at least one textile fiber is fiberglass.

63. A composition according to claim 62 wherein the substrate comprises a silicone lubricant precoating.

64. A composition according to claim 55 wherein said at least one non-fluoropolymer is a thermoplastic polymer.

65. A composition according to claim 55 wherein said at least one non-fluoropolymer is selected from the group consisting of polyetheretherketones, polyetherketones, liquid crystal polyesters, liquid crystal polyester amides, polyaramides, polyetherimides, polyimides, copolyimides, polyethersulfones, polybenzoxazoles, polybenzimidazoles, polycarbonates, polysulfones, polyketones, polyphenylene sulfides, and combinations thereof.

66. A composition according to claim 65 wherein the particle size of the at least one non-fluoropolymer is from 0.01-200 microns.

67. A composition according to claim 65 wherein said at least one non-fluoropolymer is a polyetheretherketone.

68. A composition according to claim 65 wherein said at least one non-fluoropolymer is a liquid crystal polyester or a liquid crystal polyesteramide.

69. A composition according to claim 65 wherein said at least one non-fluoropolymer is a polyimide.

70. A composition according to claim 65 wherein said at least one non-fluoropolymer is a polyetherimide.

71. A composition according to claim 55 wherein said at least one non-fluoropolymer is a thermoset polymer.

72. A composition according to claim 55 wherein the polymer composition additionally comprises an inorganic filler.

73. A composition according to claim 72 wherein the inorganic filler is aluminum oxide.

74. A composition according to claim 55 wherein the polymer composition forms an interpenetrating network of the fluoropolymer component and the non-fluoropolymer component.
